(19) United States
(12) Patent Application Publication
(10) Pub. No.: US 2026/0100755 A1
(43) Pub. Date: Apr. 9, 2026

(54) CONNECTING WI-FI-ENABLED DEVICE TO NON-TERRESTRIAL SATELLITE CONSTELLATIONS

(71) Applicant: Dell Products L.P., Round Rock, TX (US)

(72) Inventors: Michael J. Healy, Scituate, MA (US); Tejinder Singh, Manotick (CA); Navjot Kaur Khaira, Manotick (CA)

(21) Appl. No.: 18/899,909

(22) Filed: Sep. 27, 2024

(51) Int. Cl. H04B 7/185; H04B 7/005; H04B 7/04

(52) U.S. Cl. CPC H04B 7/18539; H04B 7/005; H04B 7/04013

(57) ABSTRACT

The technology described herein is directed towards a transcoder that can be used to couple non-terrestrial network satellites to user equipment, including by decoding and reencoding data packets at the packet level. A metasurface (reconfigurable intelligent surface, or RIS) redirects signals from the satellite to a satellite radio frequency (RF) interface of the transcoder, with the transcoder also coupled by a Wi-Fi RF interface to user equipment, such as a computing device or cellphone. The transcoder converts, at the packet level, satellite-originating signals to Wi-Fi-compliant signals, and converts Wi-Fi-originating signal to satellite-compliant signals. The transcoder performs various additional conversion-related functions to facilitate such satellite service, including via frequency conversion, doppler manipulation, a repeater, frequency equalization/negative-slope compensation and RIS-related conversion in both the receive mode and transmit mode of the RIS. Various example form factors for implementing and deploying the transcoder and metasurface can be used.

### RELATED APPLICATION

The subject patent application is related to U.S. patent application Ser. No. 18/780,254, filed Jul. 22, 2024, and entitled “TRANSCODING THE AIR-INTERFACE BETWEEN NON-TERRESTRIAL AND TERRESTRIAL NETWORKS LEVERAGING INTEGRATED METASURFACES” (docket no. 139018.01/DELLP1230US), the entirety of which patent application is hereby incorporated by reference herein.

### BACKGROUND

The reliability of non-terrestrial network satellite service is problematic, especially when a communicating device moves to an indoor environment, due to various radio frequency signal attenuations introduced by a roof, wall, or other physical structures that are between a satellite and the communicating device. As such, present satellite communication (non-terrestrial network) services basically require a line-of-sight (LoS) path between a satellite and a user equipment device to reduce radio frequency signal fading or shadowing in order to provide reliable communication. Further, the air-interfaces of satellite communications (Satcom, sometimes “SatCom” and other times “SATCOM”) and those used for terrestrial data communications (e.g., Wi-Fi) have significant differences, including having to comply with different standards from one another.

### BRIEF DESCRIPTION OF THE DRAWINGS

The technology described herein is illustrated by way of example and not limited in the accompanying figures in which like reference numerals indicate similar elements and in which:

FIG. 1 is a representation of multiple example locations for deploying a metasurface (reconfigurable intelligent surface, or RIS) indoors, including metasurfaces configured to operate in a transmission mode and reflection mode, in accordance with various example embodiments and implementations of the subject disclosure.

FIGS. 2A and 2B are representations of example metasurfaces configured to operate in a transmission mode and reflection mode, respectively, in accordance with various example embodiments and implementations of the subject disclosure.

FIG. 3 is a block diagram showing an example hardware-based transcoder device in which radio frequency (RF) downlink and uplink signals are connected for RF input and output, in accordance with various example embodiments and implementations of the subject disclosure.

FIG. 4 is a block diagram showing an example layer-1 physical conversion (L1-PHY) module/component of a transcoder device for Wi-Fi-enabled devices-to-Satellite communications (Satcom), in accordance with various example embodiments and implementations of the subject disclosure.

FIGS. 5A and 5B are examples of hardware-based transcoder devices for coupling a user equipment to a satellite, including via a metasurface (RIS, FIG. 5B), in accordance with various example embodiments and implementations of the subject disclosure.

FIGS. 6A and 6B are alternative examples of hardware-based transcoder devices for coupling a Wi-Fi-enabled device/user equipment to a satellite, including via one or more metasurfaces (FIG. 6B), in accordance with various example embodiments and implementations of the subject disclosure.

FIG. 7 is an example top view representation of an example unit-cell suitable for use in a metasurface that operates in a transmission mode or a reflection mode, in accordance with various example embodiments and implementations of the subject disclosure.

FIG. 8 is an example top view representation of an example metasurface panel that can be configured to operate in a transmission mode or a reflection mode, in accordance with various example embodiments and implementations of the subject disclosure.

FIG. 9 is an example bottom view representation of an example metasurface panel. with a metallic backplane attached to operate the metasurface in a reflection mode, in accordance with various example embodiments and implementations of the subject disclosure.

FIG. 10 is an example bottom view representation of the example metasurface panel of FIG. 4, with the metallic backplane removed to operate the metasurface in a transmission mode, in accordance with various example embodiments and implementations of the subject disclosure.

FIG. 11 is a conceptual representation of an example of a metasurface configured to operate in a reflection mode, in accordance with various example embodiments and implementations of the subject disclosure.

FIG. 12 is a graphical representation of example simulated reflection performance of a unit-cell for a metasurface with a metallic backplane attached for operating in a reflection mode over the n255 frequency band, in accordance with various example embodiments and implementations of the subject disclosure.

FIG. 13 is a conceptual representation of an example of a metasurface configured to operate in a transmission mode, in accordance with various example embodiments and implementations of the subject disclosure.

FIG. 14 is a graphical representation of example simulated transmission performance of a unit-cell of a metasurface with no metallic backplane for operating in a transmission mode over the n255 frequency band, in accordance with various example embodiments and implementations of the subject disclosure.

FIG. 15 is a graphical representation of an example comparison of the side length of a metasurface for a desired array gain for different non-terrestrial network lower frequency bands and higher frequency bands, in accordance with various example embodiments and implementations of the subject disclosure.

FIG. 16 is a graphical representation of example total numbers of unit-cells configured on metasurface panels for specific array gains for different frequencies, in accordance with various example embodiments and implementations of the subject disclosure.

FIG. 17 is a representation of an example system-level end-to-end network showing how a data packet is communicated from an indoor notebook, via a metasurface, to and from a space mesh network, in accordance with various example embodiments and implementations of the subject disclosure.

FIG. 18 is a flow diagram showing example operations related to converting a terrestrial uplink wireless fidelity (Wi-Fi) communication signal to a non-terrestrial uplink communication signal including decoding first packet data in the first uplink communication signal, and outputting the non-terrestrial uplink communication signal, in accordance with various example embodiments and implementations of the subject disclosure.

### DETAILED DESCRIPTION

The technology described herein is generally directed towards connecting Wi-Fi-enabled devices/user equipment (UE) (e.g., commercial-off-the-shelf devices) to the legacy satellite Satcom communication protocol, whereby Wi-Fi-enabled devices are able to communicate with satellite services. Thus, for example, via the technology described herein, Wi-Fi-enabled devices such as notebook computers and cellphones can connect directly to satellites with no modification to the legacy satellite or to the Wi-Fi-enabled device. This is significant because many satellites were put into orbit many years ago, whereby changing their native air-interface is impractical, and at the same time Wi-Fi-enabled devices based on Wi-Fi protocols are prolific, e.g., as defined by IEEE (Institute of Electrical and Electronics Engineers) 802.11-based standards.

As will be understood, based on the technology described herein, wireless Wi-Fi-enabled devices can communicate directly with satellites, which includes not only legacy satellites, but those recently (or not yet) deployed. To this end, a transcoder is described, where the term “transcode” and the like (“transcoding,” “transcode,” “transcoded”) generally refers to the two very different air-interfaces being converted from one standard to another standard. This includes Layer-1 physical (L1-PHY) packet level decoding of the downlink satellite-compliant signal, and reencoding to a downlink Wi-Fi-compliant signal, and in the opposite direction, that is, L1-PHY packet level decoding of the uplink Wi-Fi-compliant signal, and reencoding to an uplink satellite-compliant signal.

Thus, the technology described herein transcodes the Satcom industry standard air-interface to the Wi-Fi wireless standard, and vice-versa. In addition to packet-level conversion, example protocols and resources that can convert, through the transcoding process, include, but are not limited to, doppler shifting/correction/compensation, frequency up/down conversion, modulator/demodulator, frequency equalization, negative-slope compensation, repeater, re-clocking, amplification, power levels, and the like.

Further, the integration of a metasurface, or reconfigurable intelligent surface (RIS integration) facilitates portability and disaggregation. More particularly, while the indoor radio frequency (RF) signal is converted using the transcoding technology described herein, the indoor RF signal needs to get outdoors to achieve line-of-sight (LoS) connectivity directly to the satellite. RIS technology provides the capability to transmit the indoor RF signal to the outdoor environment, that is, transmit the Wi-Fi signal from indoors-to-outdoors and outdoors-to-indoors wirelessly, eliminating the need for a physical cable to connect a mounted outdoor antenna to indoor Wi-Fi-enabled devices. Among other benefits, a RIS also adds the benefit of portability, and different ways to deploy the transcoder device. For example, the transcoder device can be standalone box, integrated into an antenna, tether-box attached to notebook, and so on. The transcoder device and RIS also can be disaggregated, e.g., to have some components/features in a computing device such as a notebook, and other components/features in an external RIS/antenna.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and metasurfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

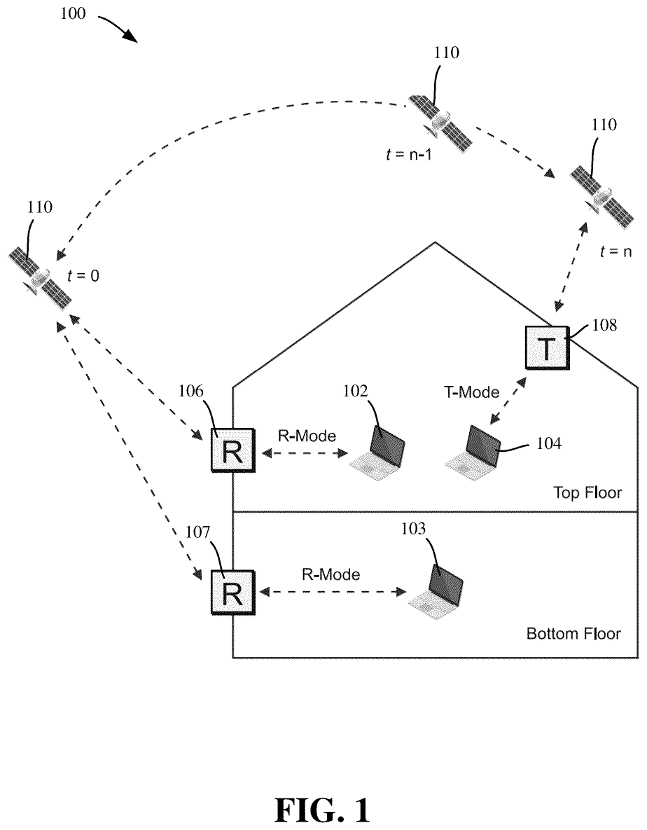

FIG. 1 is a representation of an example environment 100 including Wi-Fi-enabled device 102-104 (user equipment) operating indoors, and metasurfaces 106-108. As described herein, the metasurfaces 106-108 are used to offer signal boost in the standardized non-terrestrial network frequency bands.

In general, a metasurface (sometimes referred to as a reconfigurable intelligent surface, or RIS) of unit cells is deployed between a satellite and a Wi-Fi-enabled device. The metasurface can be configured to act as a passive signal gain booster to provide a reliably connected non-terrestrial network service, including in indoor Wi-Fi-enabled device scenarios. There is significant signal attenuation experienced by non-terrestrial network services with respect to penetrating indoor environments. Such variability in attenuation, influenced by construction materials and their moisture content, impedes the reliability and performance of direct-to-device connections. This attenuation can range from minimal to severe, ranging from 3 dB (50%) to virtually complete attenuation; for example, metal roofing and attics equipped with radiant barriers present the most challenging conditions, exhibiting signal losses up to 30 dB (99.9% reduction).

To counteract such signal attenuation challenges, the integration of metasurface technology as described herein facilitates non-terrestrial network direct-to-everything service reliability, by using a (for example portable) designed metasurface to boost the attenuated RF signals to and from a satellite, to ensure an end-to-end link supporting always-on connectivity. In general, metasurfaces are surfaces engineered to manipulate electromagnetic waves, offering a pathway to enhance signal strength in either reflection or transmission modes. A metasurface such as described herein can be designed in a way that reduces the fabrication costs exponentially relative to other technologies, as in general a metasurface only needs a single layer of metallization on a substrate. The metasurface can be used for direct-to-everything (DTX) communications, including with Wi-Fi-enabled smartphones, laptops, and other RF devices in automotive vehicles, IoT devices, or inter-device communication, as long as the operating RF frequency is within the gain band of specially designed metasurface.

One implementation of the technology described herein includes a passive (no power needed) metasurface that can be reconfigured into reflection mode or transmission mode by simply attaching or removing a metallic backplane to or from the metasurface. More particularly, a passive metasurface signal booster does not require power to function, and the reconfiguration to the reflection mode can be achieved by attaching a metallic back plane panel to the underside of the metasurface, or removing the back plane to achieve transmission mode. These designs add additional benefits to ensure non-terrestrial network connectivity even during a power outage, which is significant for the safety and emergency response community.

In one implementation, the metasurface can be sufficiently small in size so as to be portable, which can be carried when traveling or moved within a building as needed to enhance the signal strength with respect to non-terrestrial network uplink and downlink communications. The portability of the metasurface allows a user to test out multiple candidate positions, using either a transmission mode or a reflection mode of the metasurface within the targeted indoor environment. In this way, the user knows ahead of time that the non-terrestrial network service is not limited to a single spot. This significantly increases the convenience for the user; for example, in a scenario where the roofing material of a target building only has a few dB of attenuation at non-terrestrial network service link frequency, the metasurface booster gain operating in the transmission mode is adequate to compensate for that small loss. This removes the line-of-sight requirement between the user equipment and the satellite field of view. In general, a user can sit anywhere in a room with boosted non-terrestrial network signal through the transmission mode of a suitably placed portable metasurface, which further enhance the flexibility of the non-terrestrial network service.

In general, a satellite is always in the (low attenuation) field-of-view of a metasurface with respect to the non-terrestrial network (NTN) frequency bands; before one NTN communications satellite travels out of the field of view, another one moves in. Although only a single satellite 110 is depicted in FIG. 1 (at different times t=0, 1=n−1 and t=n), it is understood that at least one satellite is typically always within the field of view of any of the metasurfaces 106-108.

In FIG. 1, the two reflecting mode (“R”) metasurfaces 106 and 107 and one transmission mode (“T”) metasurface 108 provide satellite communication signals to and from user equipment, e.g., laptop or notebook computers 102-104. Note that instead of multiple Wi-Fi-enabled computers 102-104, a single computer can be moved among the various coverage locations of the metasurfaces 106-108.

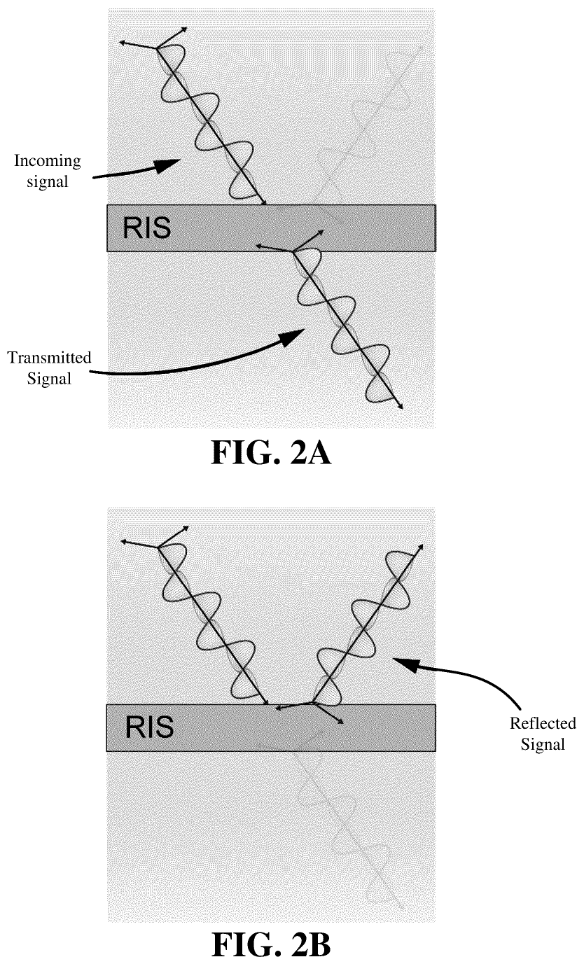

FIGS. 2A and 2B illustrate how an electromagnetic (EM) wave can be redirected by a reflective intelligent surface (RIS), through transmission or reflection, that is, FIGS. 2A and 2B show the concept of a metasurface (reconfigurable intelligent surface, or RIS) in transmission and reflection modes, respectively. As can be seen, in the transmission mode of FIG. 2A, the RIS is basically transparent to the incoming signal, and as described herein (and not explicitly shown in FIG. 2A), respective unit cells of the RIS can be designed with different phase shifts so as to passively refract respective portions of the incoming signals and thereby boost the incoming signal via constructive interference (gain array) of the different refracted respective portions of the incoming waves as refracted by the respective unit cells. Similarly, in the reflection mode of FIG. 2B, the RIS basically reflects a very large percentage of the incoming signal, and as described herein, the respective unit cells of the RIS can be designed with different respective phase shifts so as to passively reflect respective portions and boost via gain array the incoming signal via constructive interference of the different reflected respective portions of the incoming waves as reflected by the respective unit cells.

As set forth herein, the range of signal attenuation (e.g., in dB/inch) is different for various commonly used building materials such as plywood, clear glass, cinder block, drywall, and ceiling tile; each material's attenuation properties change with frequency. These building materials have lower attenuation (non-negligible) at lower frequencies, however as expected, the attenuation increases as the frequency rises, which indicates that higher frequencies face greater attenuation, which is a challenge for direct-to-device services that operate at these frequencies. However, the metasurfaces 106-108 in FIG. 1 are positioned to mitigate the attenuation issue, e.g., the two reflecting mode (“R”) metasurfaces 102 and 103 can be placed by windows or behind other low-attenuation materials, while the transmitting mode metasurface 104 can be placed near the ceiling or in line with a skylight so as to have a reasonable line-of-sight connection (i.e., low attenuation conditions) with any position of any satellite in each metasurface's field of view.

Turning to satellites in general, satellite communications (Satcom) have long been commercialized to provide mobile (aviation, sea, railroad), fixed (isolated rural area), and broadcast services for decades, while the Wi-Fi standards has gone through various 802.11 evolutions. Described herein is facilitating Wi-Fi-to-satellite use with smartphones, laptops and other devices, wherever stable connectivity can be assured between such user equipment and a satellite.

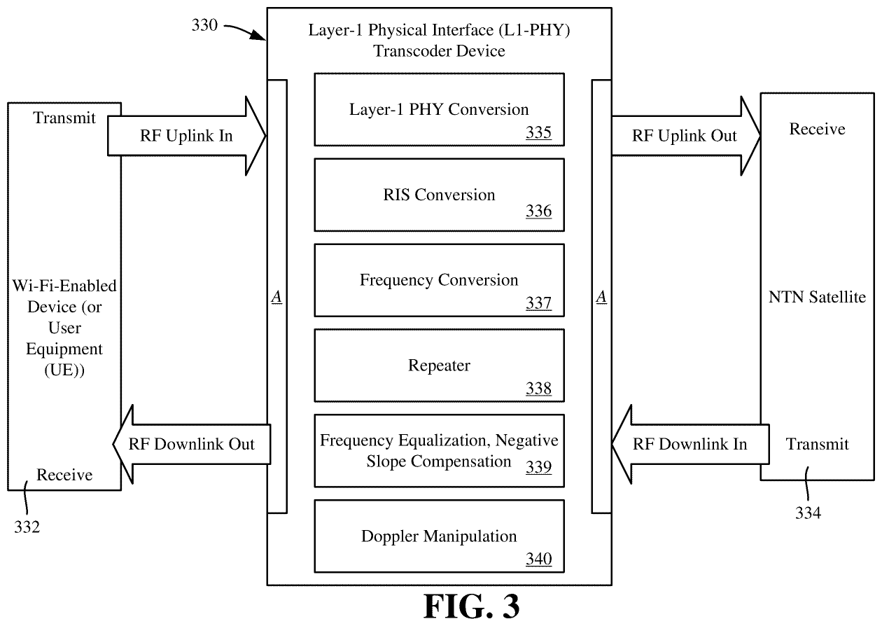

In one or more example implementations, as shown in FIG. 3, described herein is a transcoder device 330 (e.g., in the structure of a “box”) that couples a Wi-Fi-enabled device (alternatively user equipment/UE) 332 to a non-terrestrial network (NTN) satellite 334 with respect to RF uplink signals from the Wi-Fi-enabled device 332 to the satellite 334, and RF downlink signals from the satellite 334 to the Wi-Fi-enabled device 332. Various types of Wi-Fi-enabled devices can include, but are not limited to, personal (e.g., notebook/laptop) computers, other computing devices, cellphones, wireless-tether-boxes, and so on.

As shown in FIG. 3, a number of hardware and/or software-based modules/components 335-340 perform various functions related to the transcoding of RF input to RF output, in both uplink and downlink directions, according to the input protocols, formatting, and so forth, in the appropriate output format for the receiving entity. While these modules as described herein are shown separated in one example implementation, this is only one non-limiting example, and the various functionality performed thereby can be divided among more modules, and/or at least some of the example modules can be combined together to perform the transcoding-related functionality as described herein.

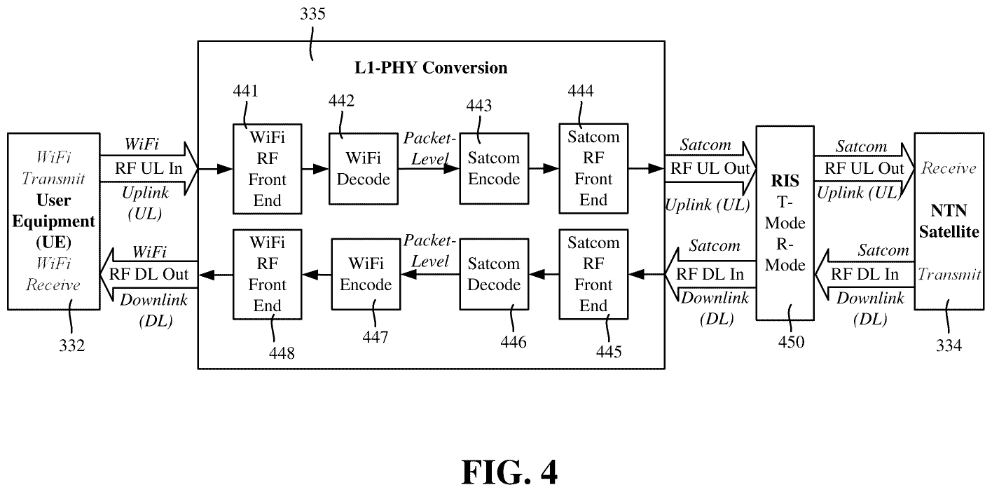

In the example of FIGS. 3 and 4, a layer-1 physical interface (L1-PHY) transcoder conversion module 335 performs L1-PHY gate-level packet-level conversion. As shown in more detail in FIG. 4, L1-PHY gate-level packet-level conversion is performed in the Wi-Fi-enabled device uplink direction, from the Wi-Fi RF front-end control interface (RFFE) 441/(e.g., Wi-Fi) decode (block 442), to the packet-level Satcom encoded (block 443)/RFFE 444 satellite uplink. In the satellite downlink direction, the L1-PHY transcoder conversion module 335 performs packet-level Satcom-to-RFFE 445 decode operations (block 446) to Wi-Fi encoded (block 447)/RFFE 448 Wi-Fi downlink packets. As shown in FIG. 3, one or more antennas A couple the transcoder device 330 to the Wi-Fi-enabled device 332 and the NTN satellite 334, which may be via a metasurface (also referred to as a reconfigurable intelligent surface, or RIS 450, FIG. 4) as described herein. More particularly, the transcoder device 330 can be integrated with reconfigurable intelligent surface (RIS) technology to relay the satellite downlink signal into the indoor environment, and vice-versa to relay the indoor Wi-Fi-enabled device signal-to-satellite uplink. This removes the constraints of line-of-sight (LoS) between the Wi-Fi-enabled device and satellite.

In the uplink direction from the Wi-Fi-enabled device, the L1-PHY conversion module 335 of the transcoder device 330 decodes (block 442) the Wi-Fi-enabled device terrestrial air-interface down to the native digital packet-level. Then the L1-PHY conversion module 335 reencodes (block 443) the packets into the legacy Satcom air-interface protocol. The downlink direction is the inverse, that is, the L1-PHY conversion module 335 decodes (block 446) the Satcom protocol to the packet-level, then reencodes (block 447) to the Wi-Fi device air-interface protocol.

With respect to Wi-Fi decoding and reencoding, note that the Wi-Fi standards are published. For the air interface, note that Satcom (Digital Video Broadcasting (DVB)-Compliant L1-PHY details are also published, including a logic block diagram of a DVB-compliant DVB-S2 Layer-1 Physical Interface (L1-PHY). The logic blocks used on the L1-PHY portion of the Satcom can be specific to the DVB-standardized Satcom protocol; the DVB standards are global standards that have defined the Satcom protocol for many years, and many deployed legacy satellites support the early DVB-S standards. Over the years the DVB consortium has moved from the original DVB-S to DVB-S2 to DVB-S2 to the latest DVB-S2X. The following summarizes some features of Satcom operation:
NTN Mode=Satcom, legacy DVB standards
L1-Physical Interface=Satcom DVB protocol L1-PHY logic blocks
Bands=Satcom satellite frequency bands, K, Ku, Ka, Q/V, S, L
Service-Link=Satcom air-interface
Feeder-Link=Satcom air-interface
Antenna Technology=varied, depends on K, Ku, Ka, Q/V, S, L bands
Physical Constraints=mobile and static wireless operation, physical challenges
Interference, Weather, Scintillation, Channel Modeling, Link-Budget=mobile and static wireless operation, various challenges
Use-Case/Market/Protocol=Satcom L1-PHY, satellite broadband providers, military, governments
Packet-Format/Tunneled-Packet=Satcom, varied packet formats through the years.

A comparison of Satcom-related air-interfaces is shown in the table below summarizing various features used by the Satcom satellite industry. The frequency bands are different from one another, and the frequencies are approved through the DVB standards organization. Some Satcom bands have been used for satellite communication for over twenty years, while newer bands have been defined or are being defined.

| | Satcom |
|---|---|
| L1-PHY | DVB-S/S2/S2X |
| Air Interface | Satcom DVB-S/S2/S2X |
| Freq Bands | Bands K, Ku, Ka, Q, V, S, L |
| | (WRC allocated) |
| Market | Mobile wireless, VSAT |
| | Broadband, fixed-satellite |
| | serves (FSS), IoT/NB-IOT |
| Use Case | Broadband, disaster-relief, |
| | emergency comms, |
| Users | VSAT, govt, military, |
| | broadband customers, |
| Satellite Era (legacy/new) | Legacy and new satellites |
| Constellations | STARLINK, KUIPER, |
| | ONEWEB, DISH / HUGHES / |
| | ECHOSTAR, SDA, |
| | GLOBALSTAR, IRIDIUM, |
| | AST, ATT, TELESAT, etc. |
| Terrestrial Network | NA |

Returning to FIG. 3, metasurface or RIS conversion, represented by block 336, is included for both the Wi-Fi-enabled device-side and the satellite-side. A metasurface, or RIS can be used to convert the downlink signal received from the satellite 334 for redirection to the Wi-Fi-enabled device 332 by including a frequency converter in between and boosting the signal amplitude, which can be, at least in part, by passive array gain. The metasurface can be similarly used with the uplink signal received from the Wi-Fi-enabled device 332 for redirection to the satellite 334. This conversion is not limited to amplitude, but can also include phase change, signal leveling, distortion compensation, up conversion, down conversion, and/or the like, by integrating radio frequency integrated circuit (RFIC) circuitry with the RIS conversion 336 functionality.

With respect to satellite and Wi-Fi frequencies, terrestrial and non-terrestrial networks use different frequency bands, without any sharing therebetween, resulting in issues in the merging of terrestrial and non-terrestrial networks when it comes to frequency bands and air-interfaces. One challenge is that, when using satellite (Satcom) frequency bands, there are significant band-rights regulation issues.

Frequency conversion is thus needed for the transcoding, and as described herein block 337 represents converting between the Wi-Fi air-interface and the Satcom air-interface frequencies. As is understood, this Wi-Fi-to-Satcom frequency (band) conversion, and Satcom-to-Wi-Fi frequency (band) conversion. In general, frequency conversion at satellite frequencies is well understood and not described in detail herein, except to reiterate that the frequency conversion of block 337 includes Satcom-to-Wi-Fi and Wi-Fi-to-Satcom frequency conversion.

A repeater (block 338) can perform other functions, such as including, but not limited to, re-clocking, amplification, and power level adjustment, and can be based on a generic transponder/frequency converter, where in general, a transponder is a broadband RF channel used to amplify one or more carriers on the downlink side of a geostationary communications satellite. A transponder is simply a repeater that takes in the signal from the uplink at one frequency, amplifies the signal and sends it back on another frequency. Satellites can have bent-pipe repeaters, which receive signals in the uplink beam, block translates them to the downlink band, and separates them into individual transponders of a fixed bandwidth. A transponder can be amplified by a traveling wave tube amplifier (TWTA) or a solid state power amplifier (SSPA).

Frequency equalization and negative-slope compensation are incorporated into block 339 of FIG. 3. One of the features of the transcoder device 330 is to equalize the frequency and create a negative image of the loss generated from the conversion, and superimpose it into an equalizer to maintain constant loss over the band. A negative slope compensation technique can be a purely passive resistor network-based technique that can be implemented in the RF chain; the equalization can be hardware-based, software-based, or a combination of both.

Another module/component shown in FIG. 3 is directed towards three-dimensional (3D) doppler shifting/correction/compensation, wherein the Doppler effect (also known as Doppler shift) is the change in the frequency of a wave from the perspective of an observer when the source of the wave and the observer are moving relative to one other. Doppler manipulation (block 340) compensates for the movement as the satellite flies overhead. To this end, the doppler manipulation 340 adjusts based on tracking the changing x-y-z dimensions of the satellite (and the observer RIS, if moving, such as in a vehicle or drone). In this way, for example, the L1-PHY transcoder device 330 can deliver hardware-based doppler-modification data to allow commercially available Wi-Fi-enabled devices (UEs) to communicate better with Satcom satellites without any Wi-Fi-enabled device modifications.

To summarize, FIGS. 3 and 4 are directed to Wi-Fi-enabled device uplink transmission, from left-to-right, and satellite downlink transmission, from right to left. The Wi-Fi-enabled device 332 (e.g., a notebook or smartphone) transmits an RF uplink signal, e.g., using a commercially available Wi-Fi-enabled components and antenna, e.g., integrated into the device. The RF uplink signal is fed into the L1-PHY transcoder box 335 for processing, and in this particular example, to the Wi-Fi RF front end component 441. The Wi-Fi RF front end component 441 thus receives the RF uplink signal from the user equipment 332 and processes the signal. The front-end handling can include initial filtering, amplification, and/or frequency conversion used for further processing.

For decoding to the packet level, the processed RF signal is decoded down to the packet level using Wi-Fi logic blocks. Standards/definitions for IEEE Wi-Fi logic blocks (e.g., each Wi-Fi PHY packet contains a preamble, header and payload data) frames and so on are published and thus are not described herein in detail. Decoding can include equalization, demodulation and/or forward-error-correction decoding to extract the data packets from the RF signal. Packet-level transcoding operates via packet conversion, in which the decoded Wi-Fi packets are converted to Satcom packets. This ensures that the data can be accurately and efficiently transmitted over the satellite communication uplink. In one example implementation, Satcom encoding is based on reencoding the packets using Digital Video Broadcasting (DVB)-compliant Satcom layer-1 protocols. This involves preparing the data for transmission over satellite networks, which can include modulation and forward-error-correction encoding tailored to the DVB Satcom requirements.

The encoded signal is passed through the Satcom RF front end, where it is prepared for RF output/transmission. This can include initial filtering, amplification, and/or frequency conversion to match the satellite uplink requirements. The RF uplink output is then transmitted through the RIS component(s) 450 to the NTN satellite 334.

The downlink (receive/RF downlink in) process with respect to reception by the Wi-Fi-enabled device 332 of the NTN satellite downlink communication signal is shown in the opposite direction in FIGS. 3 and 4. In general, The NTN satellite 334 transmits an RF downlink (DL) signal, which is received by the RIS component(s) 450. In turn, the RIS component(s) 450 forwards the received signal to the transcoder device 330 (FIG. 3), and in this example, to the Satcom RF front end component 445.

When the RF downlink signal enters the Satcom RF front-end component 445, the downlink signal is initially processed, which can include filtering and amplification. The processed RF signal is then decoded (block 446) down to the packet level using DVB logic blocks. This can include equalization, demodulation and forward-error-correction decoding to extract the data packets from the RF signal.

Packet-level transcoding of the downlink signal also operates via packet conversion, that is, the decoded Satcom packets are converted to Wi-Fi packets. This ensures the data can be accurately and efficiently transmitted over the Wi-Fi communication link. In general, the decoded downlink packets are reencoded (block 447) using Wi-Fi specific L1-PHY protocols. This involves preparing the data for transmission over the Wi-Fi network, which can include modulation and forward-error-correction tailored to Wi-Fi requirements.

The reencoded downlink signal is passed through the Wi-Fi RF front end component 448, where it is prepared for transmission back to the user equipment 332. This can include filtering, amplification, and/or frequency conversion to match the terrestrial Wi-Fi downlink requirements. The prepared Wi-Fi RF downlink output signal is then transmitted back to the user equipment 332 (e.g., a notebook or smartphone).

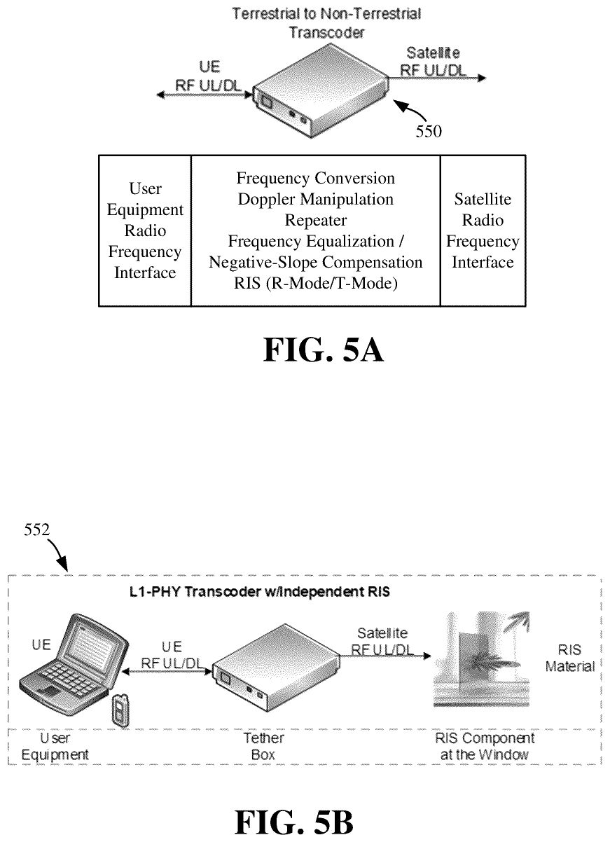

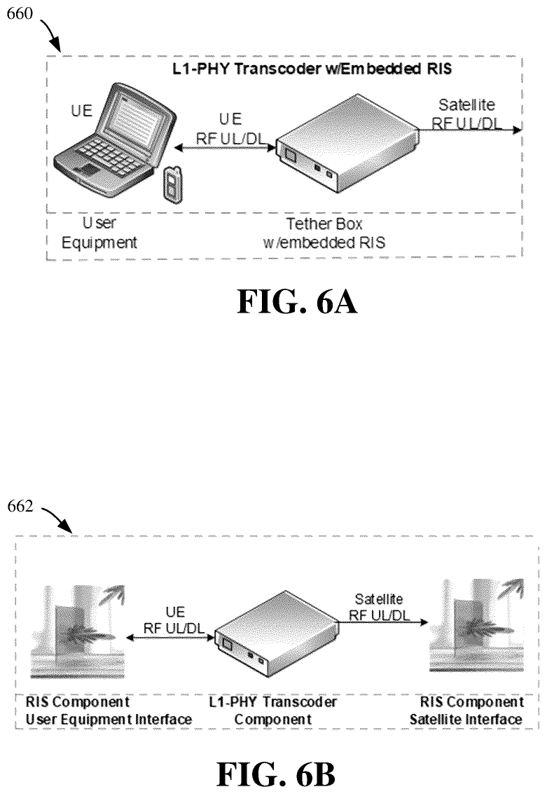

FIGS. 5A, 5B, 6A and 6B shows some example, nonlimiting physical form factors suitable for the transcoder device 330 of FIG. 3, in which the terrestrial to non-terrestrial transcoder device 330 is implemented as a hardware product with software code running on the hardware. The internal transcoder includes printed circuit boards (PCBs), silicon chipsets, antennas, and RF components, which in general, are intended to meet a very low-cost market, including that the enclosures, PCBs, and other physical components can be commercially available, off-the-shelf components.

For example, FIG. 5A shows a standalone box configuration 550, which, as shown via block 552 of FIG. 5B, can be RF coupled (e.g., tethered) to a metasurface (an independent RIS) with respect to signal redirection from and to a satellite, and/or from and to user equipment. An advantage of this form factor is that more than one RIS/RIS component can connect to the L1-PHY transcoder box 552, providing more coverage. Note that a standalone box configuration 550 can be implemented in a very small aperture terminal (VSAT)-type system.

FIG. 6A shows a tether-box transcoder in block 660 with an embedded RIS coupled to a Wi-Fi-enabled device; it is understood that the transcoder circuitry can likewise be embedded into RIS circuitry. FIG. 6B shows an L1-PHY transcoder 662 with RIS coupling to both a Wi-Fi-enabled device and a satellite. As with FIG. 6A, an advantage of this form factor is that multiple RIS components can connect to the L1-PHY transcoder box, providing more coverage for both the Wi-Fi-enabled device-side and satellite-side.

Note that the RIS of FIG. 6B can be designed as two independent metasurfaces, one designed for a Wi-Fi-enabled device frequency band, and one designed for a satellite frequency band. Alternatively, a single RIS can be designed for two (or more) different frequency bands, e.g., with different sections of the metasurface designed for redirecting the different frequency bands. Thus, although depicted as separate RIS components in FIG. 6B, there can be a single RIS component for both the Wi-Fi-enabled device and the satellite interfaces. For example, a user can mount a single RIS at a window location, with the RIS used to redirect signals from the satellite section of the RIS to the transcoder box, and from there to the Wi-Fi-enabled device, as well as from the Wi-Fi-enabled device (via the Wi-Fi-enabled device section of the RIS) to the transcoder box, and then back to the satellite section of the RIS, such as when the Wi-Fi-enabled device is using a millimeter-wave frequency or the like that is blocked from communicating directly (is non-LoS) with the transcoder box.

Turning to addition details of the metasurface (RIS), in one or more example implementations, described herein is a passive portable metasurface that can be manually configured to operate either in reflection mode (R-Mode) or in transmission mode (T-mode) to service various device(s)/Wi-Fi-enabled device(s), e.g., as shown in FIG. 1. The portable metasurfaces can be designed in a way to offer signal boost in standardized non-terrestrial communication bands such as Wi-Fi without requiring any power source, providing indoor usage scenarios as well as a travel-ready solution for remote areas, and/or during emergency situations when power is not available.

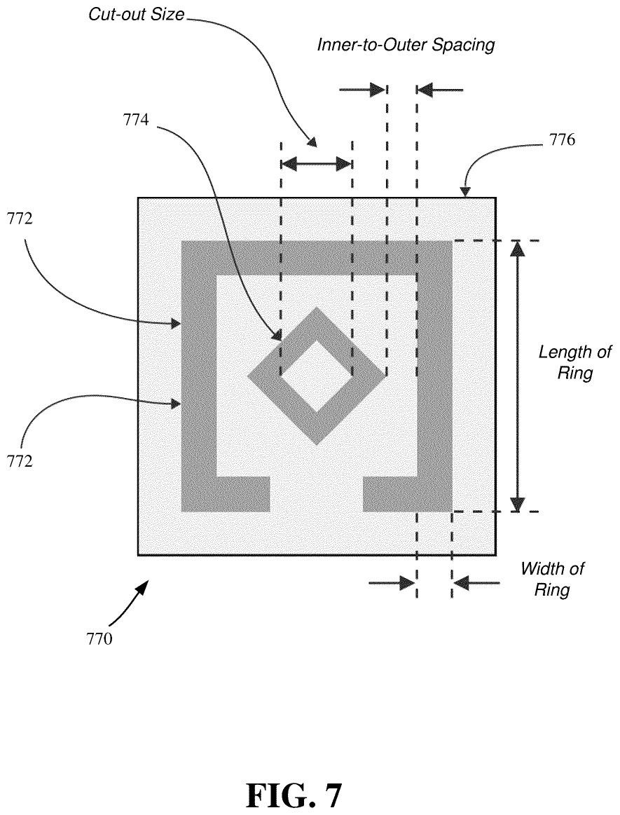

FIG. 7 shows one example design of a unit cell 770 of a metasurface. In this example, the unit cell 770 has a metallic resonating pattern shaped as square split ring (outer shape 772) with a central rhombus (inner shape 774). The pattern is formed from a thin metal film on a dielectric substrate 776. The dimensions of the unit cell 770 determine the frequency at which the unit cell resonates, and are thus sized based on the frequency band of the incoming signal, e.g., the n255 or n256 satellite bands. Smaller dimensions can be used for higher frequencies, such as millimeter wave/FR2 frequencies. Note that FIG. 7 is only one non-limiting example, and that the metallic resonator pattern of a unit cell can be of any shape and size as long as the metallic resonator pattern resonates at the desired frequency.

Scaling of the rhombus shape, or by rotating the inner shape 704, allows the phase of the unit-cell to be tweaked; in this way, a metasurface's unit cells can be coded as per the phase-codebook of the metasurfaces for beam redirection, given an incoming signal from a known general direction relative to the metasurface, e.g., from the sky for a satellite. Various design dimensions are shown in FIG. 7 to better illustrate the optimization variables. This shape of the unit-cell can be developed on any choice of commonly available dielectrics including but not limited to FR4 laminates, Rogers RF substrates, alumina, sapphire, glass, ceramics, or other non-metallic substrates, as long as the unit-cell shows a resonance peak at the desired frequency.

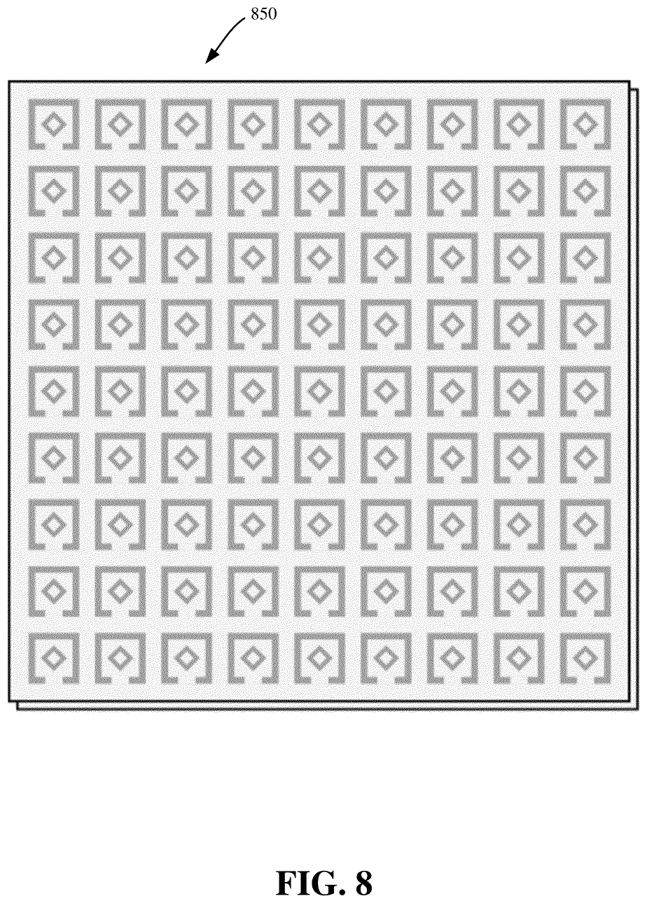

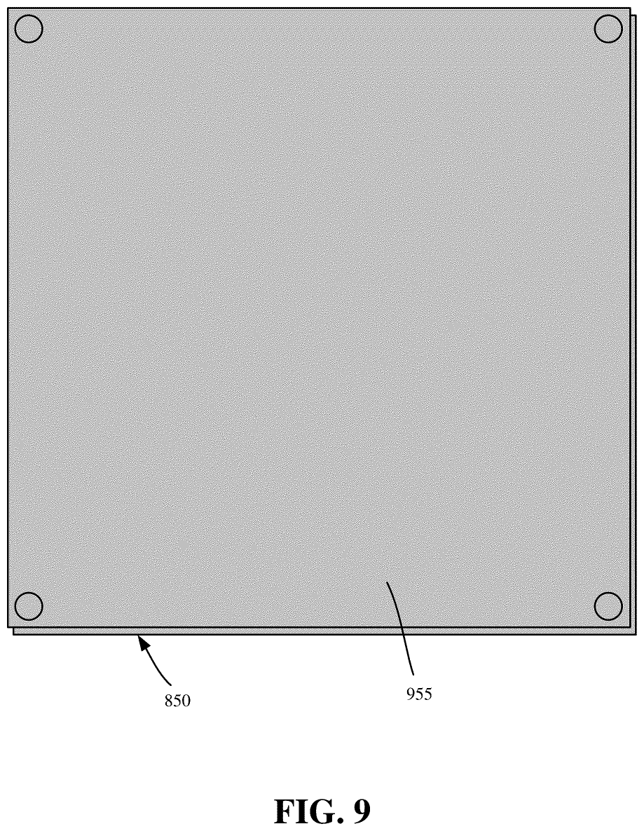

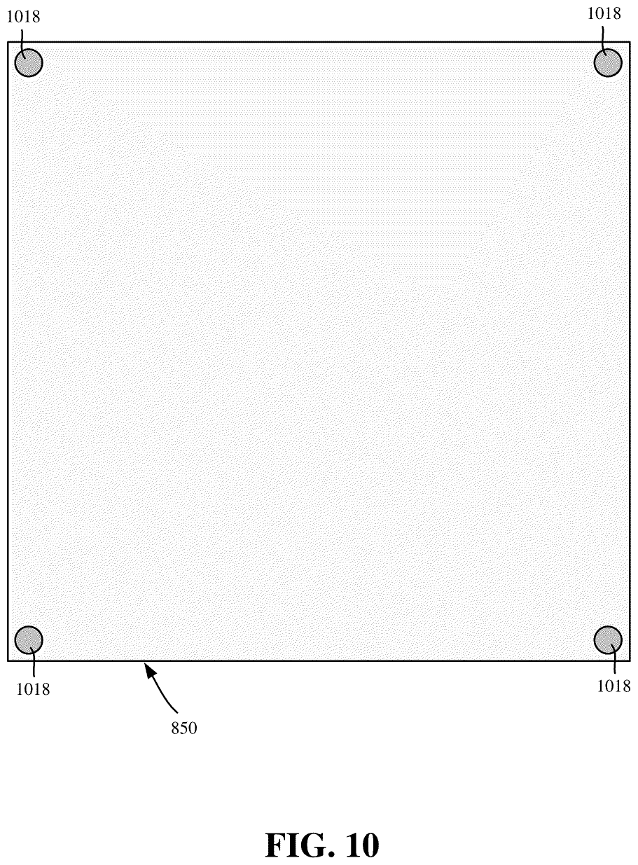

FIGS. 8-13 show the concept of a metasurface 850 of unit cells (top view, FIG. 4) highlighting the manually attachable metal backing plane 955 for reflection mode (R-mode) when attached (FIG. 9). Without the metal backing, that is, when the metal backplane is detached, the panel works in default transmission mode (T-mode), as represented in FIG. 10.

Thus, in one implementation, a complete panel (which can be portable) includes two physical sections; one section is the array of metasurface unit cells (FIG. 4) patterned on a metal layer formed on the dielectric substrate, while the second is a solid metal sheet that functions as a back plane. When the metal panel 955 is attached to the back of the metasurface array as in FIG. 9, the metasurface 850 inherently operates in the reflection mode, bouncing the enhanced signals back in the reflecting direction, allowing signals to be reflected from the panel with improved signal strength due to array gain from constructive interference, resulting from different configured phase shifts of the unit cells. When the metasurface is used without the back plane as in FIG. 10, it operates in a transmission mode, allowing signals to pass through the panel with improved signal strength due to array gain from constructive interference.

In one design implementation, a magnetic attachment system (e.g., with magnets 1018 for aligning and attached the metal back plane for the R-mode) is used to couple the back plane 955 to the underside of the unit cell surface, which simplifies the alignment when transitioning between transmissive and reflective operating modes. By simply placing or removing the back plane, a user can switch the metasurface between its two modes of operation, making the system highly adaptable for different communication scenarios.

It should be noted that while such an inexpensive back plane option allows straightforward reconfiguration of the operating modes of a metasurface, this is a non-limiting example. For example, one user may want a ceiling-mounted metasurface for operating only in the transmission mode, and can thus purchase one without a back plane. In contrast, a different user may want a window-mounted backplane for operating only in the reflection mode, and can purchase a metasurface with a fixed (non-detachable) back plane for presumably less cost than a metasurface with a selectively detachable back plane.

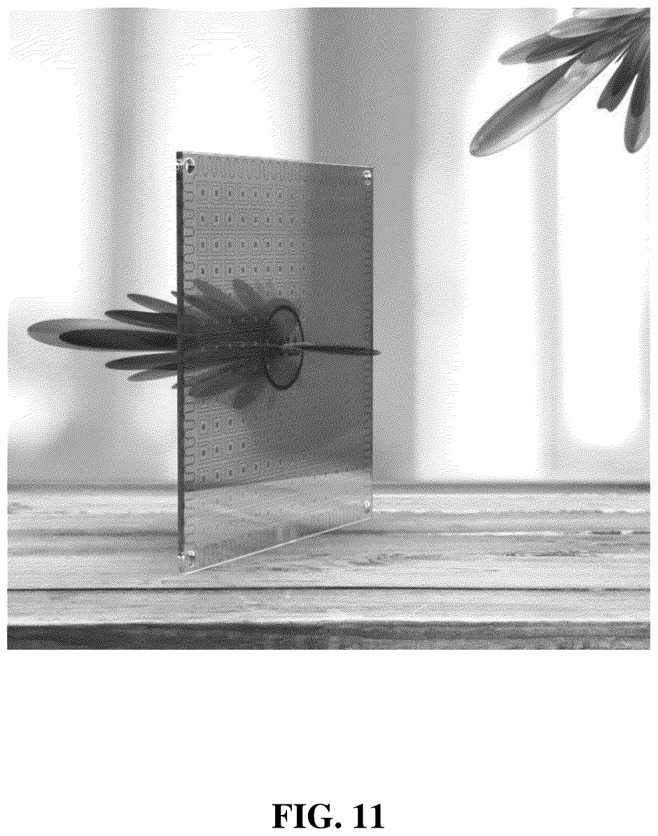

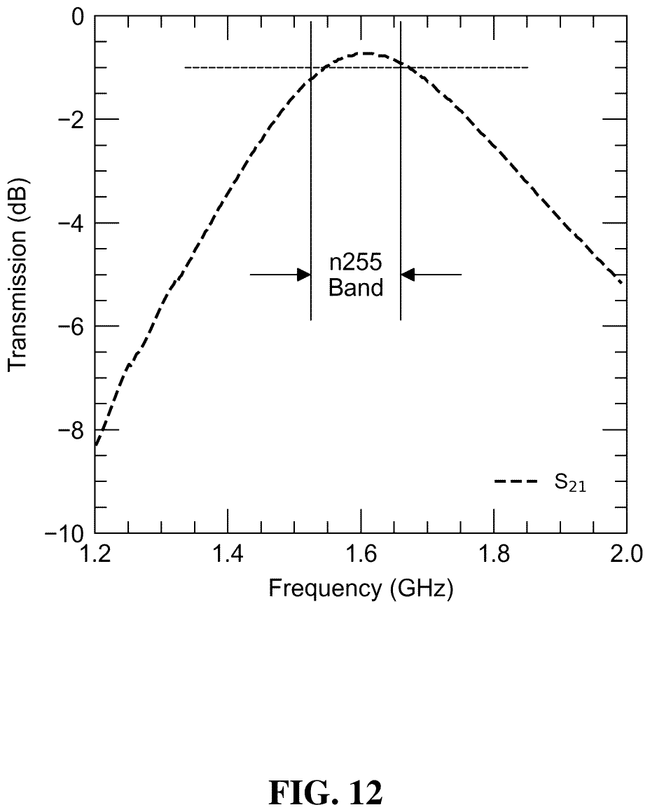

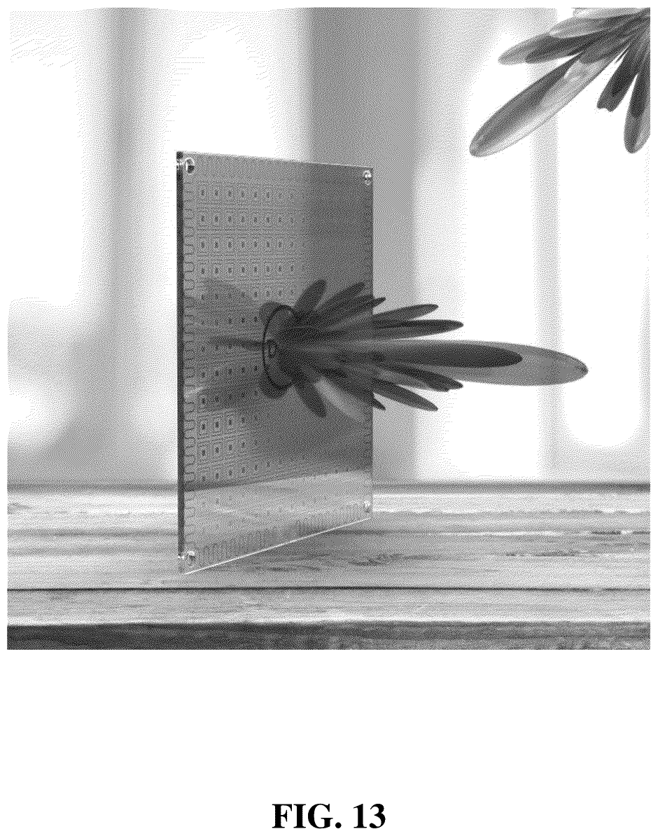

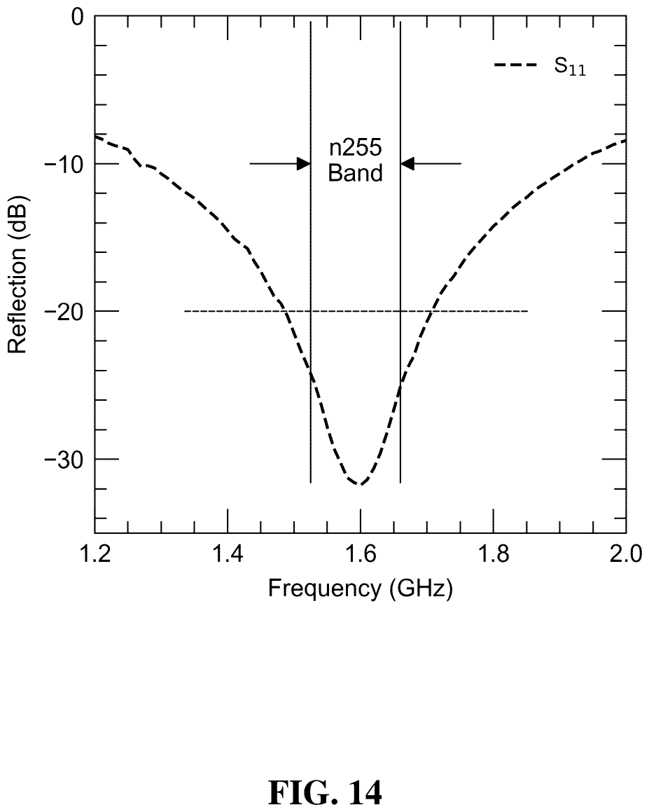

For evaluation purposes, the metasurface parameters were designed for a few frequencies in FR1 and FR2 bands to prove the viability of the technology described herein. One frequency band selected was the n255 band (1.6 GHZ) for its wide adoption in North America, with a portable dual mode metasurface designed to operate between the entire n255 band to cover both uplink and downlink communications. The operation of the designed metasurface in transmission mode along with its optimized performance in the n255 band is shown in FIGS. 11 and 12, and similarly, the metasurface in reflection mode with its performance is depicted in FIGS. 13 and 14.

FIG. 11 shows a rendered concept of a metasurface operating in the transmission mode. FIG. 12 shows the EM simulated transmission of the unit-cell for the portable metasurface over the n255 band, with the metal backplane detached. FIG. 13 shows a rendered concept of a metasurface operating in the reflection mode. FIG. 14 shows the EM simulated reflection of the unit-cell for the portable metasurface over the n255 band with the metallic back plane attached.

The electromagnetic response of the unit cell was evaluated using an industry standard high frequency EM simulation tool. As depicted in FIGS. 11 and 12, the panel's operation in transmission mode is characterized by a signal transmission magnitude S₂₁ of ≈−0.7, indicating that the panel is transmitting nearly all of the incoming signal. Conversely, FIG. 13 shows a rendered concept of a metasurface operating in the reflection mode. FIG. 14 illustrates the panel's performance in reflection mode, where the signal reflection magnitude S₁₁ is ≈−32 dB, which means the metasurface panel allows reflects all of the incoming signal, that is, FIG. 14 shows the EM simulated transmission of the unit-cell for the portable metasurface over the n255 band, with the metal backplane attached.

While the FR2 band has not been standardized yet, for evaluation purposes 19 GHz was selected for uplink communications and 28 GHz for downlink communications. Note that one metasurface that was designed for 28 GHz has experimentally measured a 35 dB gain, which is adequate to cancel out the maximum attenuation encountered in standard building infrastructures; thus for 28 GHz, experimental measured data demonstrates that the technology described herein works for millimeter wave metasurfaces, indicating the desirability of such metasurfaces for non-terrestrial network direct-to-everything links.

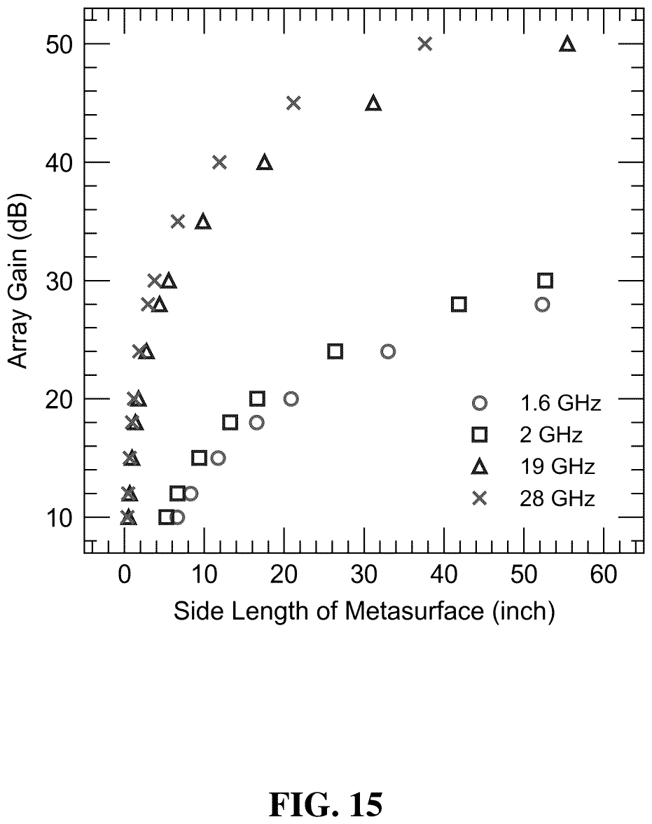

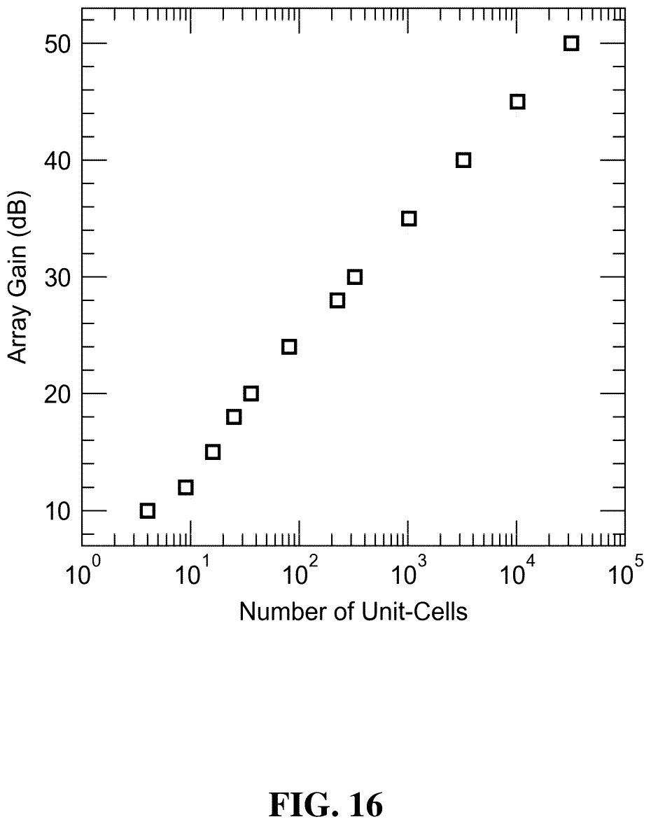

FIG. 15 shows a comparison of the side length of the metasurface for a desired array gain for different non-terrestrial network frequency bands. FIG. 16 shows the total numbers of unit-cells configured on a panel for a specific array gain. More particularly, the metasurface described herein is scalable and thus offers a choice on the size and gain, in which FIG. 16 depicts the relationship between the physical dimensions of a metasurface and its performance in terms of array gain at various non-terrestrial network frequency bands. As can be seen in FIG. 16, for chosen frequencies, as the side length of the metasurface increases (for the same design and fabrication materials), the array gain also increases.

This attests to the relationship that a larger physical aperture (larger number of unit cells in the array) of the metasurface usually results in a higher gain. Notably, at higher frequencies such as 19 GHz and especially at 28 GHz, the gain increases significantly even with a smaller increase in the side length of the metasurface. This indicates that operating at higher frequencies may allow for more compact metasurfaces to achieve high gains, which facilitates a metasurface suitable for carrying by a user, such as if a user travels to a remote area where non-terrestrial network service is the best way to keep connected with the rest of the world. Similarly, in FIG. 19, the plot indicates that as the number of unit-cells in the metasurface increases, the array gain also increases. This relationship is expected, as more unit-cells typically mean a greater ability to shape and direct the electromagnetic waves, leading to higher gain. Note that the number of unit cells is not frequency dependent.

The limitation of each metasurface supporting only one frequency band will be diminished as more bands are standardized for the non-terrestrial network broadband market. From a user's point of view, once a user subscribes to the non-terrestrial network, the service link frequency is already known for a designated region, such that the user can purchase a metasurface that performs for the relevant frequency in the region it will be deployed.

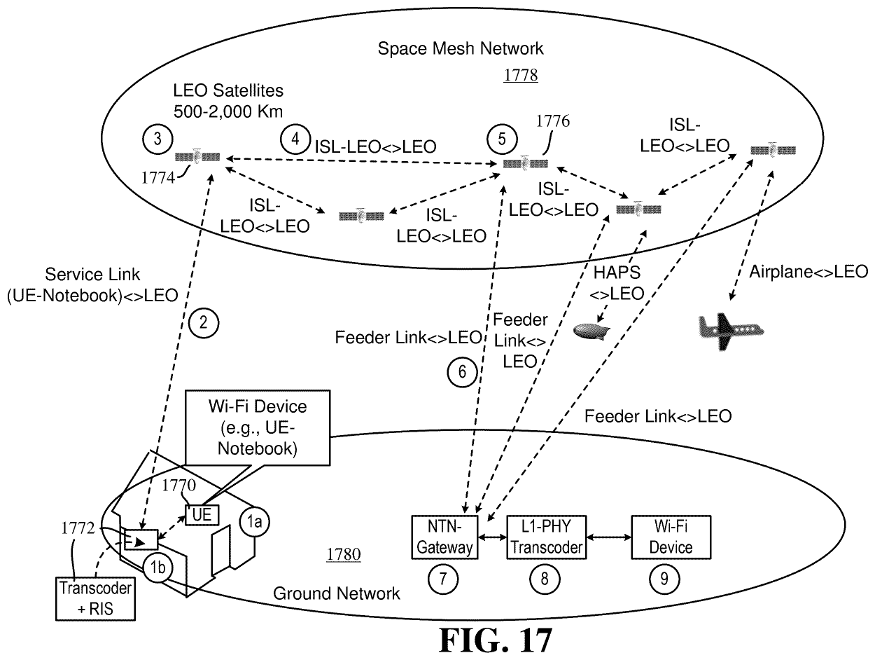

In general, non-terrestrial network airborne networks may be intra-continent, or span across oceans and multiple continents, as a non-terrestrial network is a global network. By way of example, consider the travels/life of a data packet in a system-level end-to-end network as generally represented in FIG. 17, in which acronyms include inter-satellite link (ISL), low earth orbit (LEO) and high-altitude platform systems (HAPS).

The example of FIG. 17 shows a non-terrestrial network end-to-end deployment of a Wi-Fi-enabled device (notebook computer) and provides a life-of-a-packet description, in which circled numerals represent communications (alphanumerically labeled arrows) and components/component operations (numerically labeled blocks). Analysis of the packet starts inside a home, e.g., on the East coast of the United States, in which a notebook computer 1770 is shielded by a house roof, walls, windows, and/or doors.

Labeled arrow (1a) represents packets leaving the notebook 1770. Arrow (1b) represents the packets being reflected out of the interior of the home using the metasurface panel technology (RIS 1772) described herein.

Arrow (2) represents the packets traveling through the air interface to a first LEO satellite 1774 using the service-link as described herein. Once inside the satellite (labeled block (3)), the Satcom (converted Wi-Fi channel) packet is repeated (amplified/frequency-converted).

At arrow (4), the Satcom packet leaves the first LEO satellite 1774 through the space mesh network 1778 using the “Optical Inter-Satellite Arrow Links (ISL)”, more specifically the “ISL-LEO-LEO” link. The space mesh network 1778 is basically a router/switch in space, represented by arrow (4) passing the packets through the space network; (note that multiple space network hops are possible, both LEO and GEO (geostationary earth orbit) satellite hops). The satellite physical interface is the inter-satellite links (ISL), similar to the optical interfaces used in ground networks.

Once the Satcom packet gets close to its destination, in this example it is in the western part of the United States, the packet terminates (labeled block (5)) inside the second LEO satellite 1776. As represented by arrow (6), the packet is then exported out of the second LEO satellite 1776 through the radio-frequency (RF) feeder-link downlink connection to a non-terrestrial network gateway (block (7)).

From there, the Satcom packet data can be converted to Wi-Fi packet data (block (8)) to a receiving Wi-Fi device (block (9)) as described herein. Once the data is received by the Wi-Fi device (block (9)), the read-return packet can be sent through the same exact ground-network 1780 and space mesh network 1778, returning the read-return packet to the notebook Wi-Fi-enabled device 1770.

In sum, the technology described herein facilitates an L1-PHY transcoder device (box), which can be a low-cost, low-intelligence (hardware solution, no additional software), for straightforward configuration and operation. The L1-PHY transcoder can be separated from the RIS components to again lower-the cost/complexity. This device can be implemented as a small, light box, which can be implemented in a physical footprint/form factor as small as the size of a cellphone, for example.

In general, a packet-level transcoding methodology decodes signals down to the packet-level using Wi-Fi logic blocks before re-encoding them for DVB satellite Satcom communication (and vice versa), ensuring high fidelity and minimal data loss. This approach maintains the integrity of the data while allowing efficient transcoding between different communication protocols. The L1-PHY air-interface conversion can include additional included features, such as (but not limited) doppler shifting/correction/compensation, frequency up/down converter, modulator/demodulator, frequency equalization, negative-slope compensation, repeater, re-clocking, amplification, power levels, and so on. Note that the doppler compensation technique can be hardware-based/physical doppler-shift compensation that dynamically corrects doppler as the satellite moves across the horizon; this needs no modification to the Wi-Fi-enabled device. Frequency conversion can include mobile network operator (MNO)-to-Satcom frequency (band) conversion and Satcom-to-MNO frequency (band) conversion.

The RIS provides the LOS connectivity to the satellites, and also facilitates portability and disaggregation. The indoor RF signal is converted using the transcoding technology described herein, and then uses the RIS to achieve line-of-sight connectivity directly to the satellite. The RIS technology provides the capability to transmit the RF signal outdoor to the indoor environment and transmit Wi-Fi-enabled device signal from indoor to outdoor wirelessly, eliminating the needs of a physical cable connecting outdoor antenna and indoor Wi-Fi-enabled devices, which adds the benefit of portability.

One or more embodiments can be embodied in a system, such as described and represented in the drawing figures herein. The system can include a metasurface, and a Layer-1 physical interface (L1-PHY) transcoder. The L1-PHY transcoder obtains uplink wireless fidelity (Wi-Fi) communication signals from a Wi-Fi-enabled device, converts the uplink Wi-Fi communication signals to non-terrestrial uplink communication signals for a satellite, and outputs the non-terrestrial uplink communication signals for redirection to the satellite via the metasurface. The L1-PHY transcoder obtains non-terrestrial downlink communication signals from the satellite, as redirected to the L1-PHY transcoder via the metasurface, converts the non-terrestrial downlink communication signals to downlink Wi-Fi communication signals for the Wi-Fi-enabled device, and outputs the downlink Wi-Fi communication signals to the Wi-Fi-enabled device.

The metasurface can be incorporated into the L1-PHY transcoder.

The metasurface can include a device externally radio frequency coupled to the L1-PHY transcoder.

The L1-PHY transcoder can perform at least one of: filtering, amplification, or frequency conversion on the uplink Wi-Fi communication signals.

The uplink Wi-Fi communication signals can include first encoded packet data, and the L1-PHY transcoder can convert the uplink Wi-Fi communication signals to the non-terrestrial uplink communication signals based on decoding the first encoded packet data into decoded packet data, and encoding the decoded packet data into second encoded packet data. The L1-PHY transcoder can perform at least one of: equalization, demodulation, or forward-error-correction decoding, to extract the first encoded packet data from the uplink Wi-Fi communication signals.

The L1-PHY transcoder can perform at least one of: filtering, amplification, or frequency conversion on the uplink Wi-Fi communication signals.

The non-terrestrial downlink communication signals can include first encoded packet data, and the L1-PHY transcoder can convert the non-terrestrial downlink communication signals to the downlink Wi-Fi communication signals based on decoding the first encoded packet data into decoded packet data, and encoding the decoded packet data into second encoded packet data. The L1-PHY transcoder can perform at least one of: filtering, amplification, or frequency conversion, to extract the first encoded packet data from the non-terrestrial downlink communication signals.

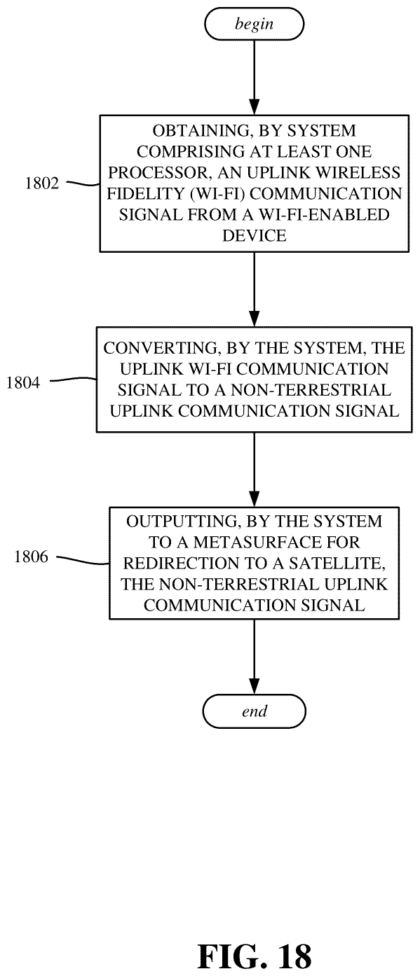

One or more example implementations and embodiments, such as corresponding to example operations of a method, or computer executable instructions/components can be represented in FIG. 18. Example operation 1802 represents obtaining, by system comprising at least one processor, an uplink wireless fidelity (Wi-Fi) communication signal from a Wi-Fi-enabled device. Example operation 1804 represents converting, by the system, the uplink Wi-Fi communication signal to a non-terrestrial uplink communication signal. Example operation 1806 represents outputting, by the system to a metasurface for redirection to a satellite, the non-terrestrial uplink communication signal.

Converting the uplink Wi-Fi communication signal to the non-terrestrial uplink communication signal can include extracting first encoded packet data from the uplink Wi-Fi communication signal, decoding the first encoded packet data into decoded packet data, and encoding the decoded packet data into second encoded packet data for output via the non-terrestrial uplink communication signal.

Extracting the first encoded packet data from the uplink Wi-Fi communication signal can include performing at least one of: equalization, demodulation, or forward-error-correction decoding.

Further operations can include performing, by the system, at least one of: filtering, amplification, or frequency conversion on the uplink Wi-Fi communication signal.

Further operations can include obtaining, by the system from the metasurface, a non-terrestrial downlink communication signal from the satellite, converting, by the system, the non-terrestrial downlink communication signal to a downlink Wi-Fi communication signal, and outputting, by the system, the downlink Wi-Fi communication signal to the Wi-Fi-enabled device.

Converting the non-terrestrial downlink communication signal to the downlink Wi-Fi communication signal can include extracting first encoded packet data from the non-terrestrial downlink communication signal, decoding the first encoded packet data into decoded packet data, and encoding the decoded packet data into second encoded packet data for output via the downlink Wi-Fi communication signal.

Extracting the first encoded packet data from the non-terrestrial downlink communication signal can include performing at least one of: equalization, demodulation, or forward-error-correction decoding.

Further operations can include at least one of: filtering, amplifying, or frequency converting, by the system, the non-terrestrial downlink communication signals.

One or more embodiments can be embodied in a system, such as described and represented in the drawing figures herein. The system can include a metasurface having a line-of-sight field of view to a satellite, and a Layer-1 physical interface (L1-PHY) transcoder that converts non-terrestrial downlink communication signals from the satellite, received by the L1-PHY transcoder as redirected via the metasurface, to downlink wireless fidelity (Wi-Fi) communication signals for a Wi-Fi-enabled device. The L1-PHY transcoder can convert uplink Wi-Fi communication signals received by the L1-PHY transcoder from the Wi-Fi-enabled device, to non-terrestrial uplink communication signals for transmission by the L1-PHY transcoder for redirection by the metasurface to the satellite. The L1-PHY transcoder can include a first packet converter to decode first packet data in the non-terrestrial downlink communication signals from the satellite, and reencode second packet data, based on the first packet data, in the second downlink Wi-Fi communication signals to the Wi-Fi-enabled device. The L1-PHY transcoder can include a second packet converter to decode third packet data in the uplink Wi-Fi communication signals from the equipment, and reencode fourth packet data, based on the third packet data, in the non-terrestrial uplink communication signals to the satellite.

The L1-PHY transcoder can obtain the first packet data from the non-terrestrial downlink communication signals based on performing, on the non-terrestrial downlink communication signals, at least one of: first filtering, first amplification, first frequency conversion, first equalization, first demodulation, or first forward-error-correction, and the L1-PHY transcoder can obtain the third packet data from the uplink Wi-Fi communication signals based on performing, on the uplink Wi-Fi communication signals, at least one of: second filtering, second amplification, second frequency conversion, second equalization, second demodulation, or second forward-error-correction.

The first packet converter can decode the first packet data based on digital video broadcasting logic blocks, and the second packet converter can decode the third packet data based on Wi-Fi logic blocks.

As can be seen, the technology described herein is based L1-PHY transcoder technology and metasurface (RIS) technology, in which the transcoder converts between the Satcom-air-interface and the Wi-Fi air-interface, including decoding and reencoding data packets at the L1-PHY packet level. This can be an L1-PHY appliance that allows a Wi-Fi model to connect directly to legacy and future LEO satellite constellations.

The technology described herein allows user equipment that communicates using the Wi-Fi mobile wireless language to communicate with satellites of a satellite constellation, both legacy constellations and newer constellations recently deployed, by passing the signals through the L1-PHY transcoder box. For non-LoS scenarios, e.g., indoor-located user equipment, communication with non-terrestrial network satellites is facilitated by using metasurface (reconfigurable intelligent surface) technology.

The technology described herein enhances signal reliability and quality by facilitating seamless communication between Wi-Fi and satellite networks. By enabling standard Wi-Fi-enabled devices to access satellite communication services, the transcoder box addresses the digital divide, providing broadband access to rural and underserved communities, for example. The dual RF front-end integration, packet-level transcoding, and NTN constellation agnostic connectivity collectively ensure robust and high-quality communication links. Further, this allows virtually any Wi-Fi-enabled UE device to communicate with NTN satellites without the need for eSIMs, cellular contracts, node-locked PC access, and so on.

The scalable and cost-effective design makes the solution economically viable, allowing for incremental upgrades and expansions, reducing initial deployment costs, while ensuring long-term adaptability to evolving network demands. By maintaining high signal quality and reducing latency, the solution enhances user experience.

The technology described herein enables WI-FI-enabled devices to connect to virtually any NTN constellation, rather than being limited to a single satellite provider's constellation. By supporting multiple satellite providers, the transcoder ensures continuous connectivity and improves coverage.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a metasurface; and
a Layer-1 physical interface (L1-PHY) transcoder that:
obtains uplink wireless fidelity (Wi-Fi) communication signals from a Wi-Fi-enabled device,
converts the uplink Wi-Fi communication signals to non-terrestrial uplink communication signals for a satellite,
outputs the non-terrestrial uplink communication signals for redirection to the satellite via the metasurface,
obtains non-terrestrial downlink communication signals from the satellite, as redirected to the L1-PHY transcoder via the metasurface,
converts the non-terrestrial downlink communication signals to downlink Wi-Fi communication signals for the Wi-Fi-enabled device, and
outputs the downlink Wi-Fi communication signals to the Wi-Fi-enabled device.

2. The system of claim 1, wherein the metasurface is incorporated into the L1-PHY transcoder.

3. The system of claim 1, wherein the metasurface comprises a device externally radio frequency coupled to the L1-PHY transcoder.

4. The system of claim 1, wherein the L1-PHY transcoder performs at least one of: filtering, amplification, or frequency conversion on the uplink Wi-Fi communication signals.

5. The system of claim 1, wherein the uplink Wi-Fi communication signals comprise first encoded packet data, and wherein the L1-PHY transcoder converts the uplink Wi-Fi communication signals to the non-terrestrial uplink communication signals based on decoding the first encoded packet data into decoded packet data, and encoding the decoded packet data into second encoded packet data.

6. The system of claim 5, wherein the L1-PHY transcoder performs at least one of: equalization, demodulation, or forward-error-correction decoding, to extract the first encoded packet data from the uplink Wi-Fi communication signals.

7. The system of claim 1, wherein the L1-PHY transcoder performs at least one of: filtering, amplification, or frequency conversion on the uplink Wi-Fi communication signals.

8. The system of claim 1, wherein the non-terrestrial downlink communication signals comprise first encoded packet data, and wherein the L1-PHY transcoder converts the non-terrestrial downlink communication signals to the downlink Wi-Fi communication signals based on decoding the first encoded packet data into decoded packet data, and encoding the decoded packet data into second encoded packet data.

9. The system of claim 8, wherein the L1-PHY transcoder performs at least one of: filtering, amplification, or frequency conversion, to extract the first encoded packet data from the non-terrestrial downlink communication signals.

10. A method, comprising:
obtaining, by system comprising at least one processor, an uplink wireless fidelity (Wi-Fi) communication signal from a Wi-Fi-enabled device;
converting, by the system, the uplink Wi-Fi communication signal to a non-terrestrial uplink communication signal; and
outputting, by the system to a metasurface for redirection to a satellite, the non-terrestrial uplink communication signal.

11. The method of claim 10, wherein the converting of the uplink Wi-Fi communication signal to the non-terrestrial uplink communication signal comprises extracting first encoded packet data from the uplink Wi-Fi communication signal, decoding the first encoded packet data into decoded packet data, and encoding the decoded packet data into second encoded packet data for output via the non-terrestrial uplink communication signal.

12. The method of claim 11, wherein the extracting of the first encoded packet data from the uplink Wi-Fi communication signal comprises performing at least one of: equalization, demodulation, or forward-error-correction decoding.

13. The method of claim 11, further comprising performing, by the system, at least one of: filtering, amplification, or frequency conversion on the uplink Wi-Fi communication signal.

14. The method of claim 10, further comprising:
obtaining, by the system from the metasurface, a non-terrestrial downlink communication signal from the satellite;
converting, by the system, the non-terrestrial downlink communication signal to a downlink Wi-Fi communication signal; and
outputting, by the system, the downlink Wi-Fi communication signal to the Wi-Fi-enabled device.

15. The method of claim 14, wherein the converting of the non-terrestrial downlink communication signal to the downlink Wi-Fi communication signal comprises extracting first encoded packet data from the non-terrestrial downlink communication signal, decoding the first encoded packet data into decoded packet data, and encoding the decoded packet data into second encoded packet data for output via the downlink Wi-Fi communication signal.

16. The method of claim 15, wherein the extracting of the first encoded packet data from the non-terrestrial downlink communication signal comprises performing at least one of: equalization, demodulation, or forward-error-correction decoding.

17. The method of claim 14, further comprising at least one of: filtering, amplifying, or frequency converting, by the system, the non-terrestrial downlink communication signal.

18. A system, comprising:
a metasurface having a line-of-sight field of view to a satellite; and
a Layer-1 physical interface (L1-PHY) transcoder that converts non-terrestrial downlink communication signals from the satellite, received by the L1-PHY transcoder as redirected via the metasurface, to downlink wireless fidelity (Wi-Fi) communication signals for a Wi-Fi-enabled device, and that converts uplink Wi-Fi communication signals received by the L1-PHY transcoder from the Wi-Fi-enabled device, to non-terrestrial uplink communication signals for transmission by the L1-PHY transcoder for redirection by the metasurface to the satellite, the L1-PHY transcoder comprising:
a first packet converter to decode first packet data in the non-terrestrial downlink communication signals from the satellite, and reencode second packet data, based on the first packet data, in the second downlink Wi-Fi communication signals to the Wi-Fi-enabled device, and
a second packet converter to decode third packet data in the uplink Wi-Fi communication signals from the equipment, and reencode fourth packet data, based on the third packet data, in the non-terrestrial uplink communication signals to the satellite.

19. The system of claim 18, wherein the L1-PHY transcoder obtains the first packet data from the non-terrestrial downlink communication signals based on performing, on the non-terrestrial downlink communication signals, at least one of: first filtering, first amplification, first frequency conversion, first equalization, first demodulation, or first forward-error-correction, and wherein the L1-PHY transcoder obtains the third packet data from the uplink Wi-Fi communication signals based on performing, on the uplink Wi-Fi communication signals, at least one of: second filtering, second amplification, second frequency conversion, second equalization, second demodulation, or second forward-error-correction.

20. The system of claim 18, wherein the first packet converter decodes the first packet data based on digital video broadcasting logic blocks, and wherein the second packet converter decodes the third packet data based on Wi-Fi logic blocks.
